(19) United States
(12) Patent Application Publication
(10) Pub. No.: US 2009/0166503 A1
(43) Pub. Date: Jul. 2, 2009

(54) COLLAPSIBLE SUPPORTING STAND

(75) Inventor: Cheng-Hung Chiu, Taichung (TW)

Correspondence Address: BACON & THOMAS, PLLC, 625 SLATERS LANE, FOURTH FLOOR, ALEXANDRIA, VA, 22314-1176, US

(73) Assignee: Rexon Industrial Corp., Ltd., Taichung (TW)

(21) Appl. No.: 12/333,419

(22) Filed: Dec. 12, 2008

(30) Foreign Application Priority Data
Dec. 26, 2007 (TW) 096150280

(51) Int. Cl. F16M 11/22

(52) U.S. Cl. 248/431

(57) ABSTRACT

A collapsible supporting stand includes a center member, at least three supporting posts and an adjustment unit. The center member has a center hole, and a plurality of receiving portions equiangularly spaced around the center hole. The supporting posts are respectively partially received in the receiving portions and respectively pivotally connected to the center member. Each supporting post has a support member fixedly provided at its top end. The adjustment unit is coupled to the center member and is vertically movable and rotatable relative to the center member, and includes a holder member and connection members. The number of the connection members is equal to the number of supporting posts. Each connection member has two opposite ends respectively pivotally connected to the associated supporting post and the holder member.

### BACKGROUND

1. Field of the Invention

The present invention relates to a stand for supporting a heavy object and more particularly, to a collapsible supporting stand for supporting a work table or machine.

2. Description of Related Art

Regular electric machine tools include two types, namely, the floor type and the tabletop type. A floor type machine tool has a big size, and is to be directly positioned on the floor for use. When a floor type machine tool is positioned on the floor, the operating interface of the machine tool is kept at an elevation suitable for operation by a user. A tabletop type machine tool is to be supported on a worktable for operation. When no worktable is available or when using a tabletop type machine tool outdoors, a stand shall be used to support the tabletop type machine tool at a suitable elevation convenient for operation.

FIG. 1 illustrates a machine tool 120 (for example, a saw machine or planer) supported on a conventional stand 100 for machining a wooden workpiece.

A regular stand for this purpose is a fixed structure that is not foldable. It is inconvenient to deliver such a fixed stand to the end use. Further, such a fixed stand requires a large amount of storage space when the fixed stand is not being used.

Therefore, it is desirable to provide a stand for a machine tool that is foldable or collapsible to facilitate storage and delivery thereof.

### SUMMARY

The present disclosure has been accomplished under the circumstances in view. Accordingly, the present disclosure provides a collapsible supporting stand, which allows quick switching between the extended operative position and the received or collapsed, non-operative position by way of the functioning of an adjustment unit to move the supporting posts.

An exemplary collapsible supporting stand according to the present disclosure includes a center member, at least three supporting posts and an adjustment unit. The center member has a center hole, and a plurality of receiving portions equiangularly spaced around the center hole. The number of the receiving portions is equal to the number of the supporting posts. The supporting posts are respectively partially received in the receiving portions and respectively pivotally connected to the center member. Each supporting post has a support member fixedly provided at its top end. The adjustment unit is coupled to the center member and is vertically movable and rotatable relative to the center member. The adjustment unit includes a holder member and connection members. The number of connection members is equal to the number of supporting posts. Each connection member has two opposite ends respectively pivotally connected to the associated supporting post and the holder member.

When using the collapsible supporting stand to support a machine tool, the adjustment unit is rotated in one direction and lowered to move the supporting posts from the collapsed or received non-operative position to the extended operative position, and then the machine tool is supported on the support members at the top of the supporting posts. When not in use, the machine tool is removed from the support members of the supporting posts, and then the adjustment unit is rotated in the opposed direction and lifted relative to the center member to collapse the supporting posts to be received together for storage or delivery.

### BRIEF DESCRIPTION OF THE DRAWINGS

FIG. 1 is an elevational view showing a machine tool supported on a stand of the PRIOR ART.

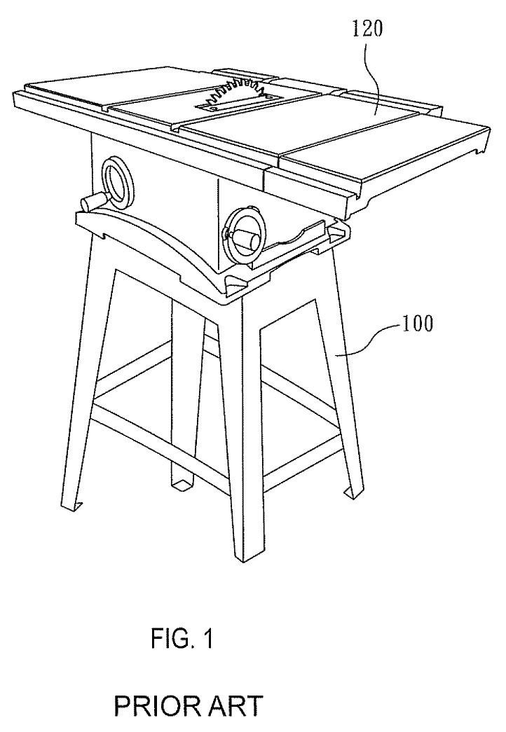

FIG. 2 is an elevational view of a collapsible supporting stand in accordance with a first embodiment of the present disclosure.

FIG. 3A is a top view of the collapsible supporting stand in accordance with the first embodiment of the present disclosure.

FIG. 3B is a schematic sectional view of a part of the collapsible supporting stand in accordance with the first embodiment of the present disclosure.

FIG. 4 is a side view of a part of the collapsible supporting stand in accordance with the first embodiment of the present disclosure.

FIG. 5 is an elevational view of the first embodiment of the present disclosure, showing the collapsible supporting stand set in the operative position and a machine tool supported on the collapsible supporting stand.

FIG. 6 is a schematic drawing showing the receiving operation of the collapsible supporting stand in accordance with the first embodiment of the present disclosure.

FIG. 7 is an elevational view showing the received status of the collapsible supporting stand in accordance with the first embodiment of the present disclosure.

FIG. 8 is an elevational view of a collapsible supporting stand in accordance with a second embodiment of the present disclosure.

FIG. 9 is a schematic sectional view of a part of the second embodiment of the present disclosure, showing the profile of one through-hole of the center member.

### DETAILED DESCRIPTION OF EMBODIMENTS

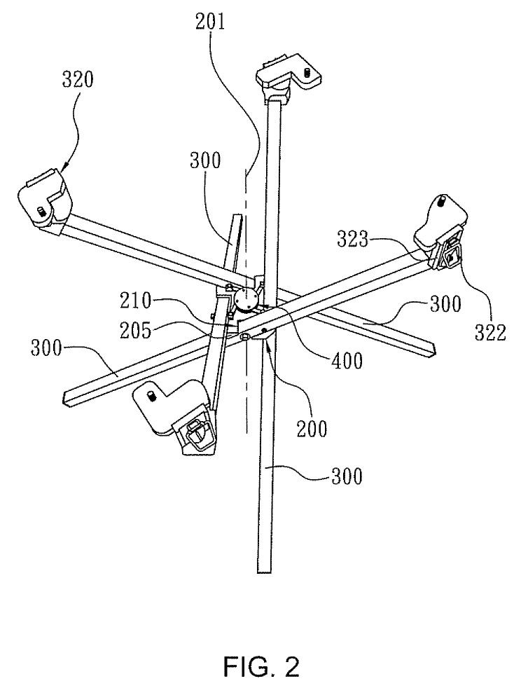

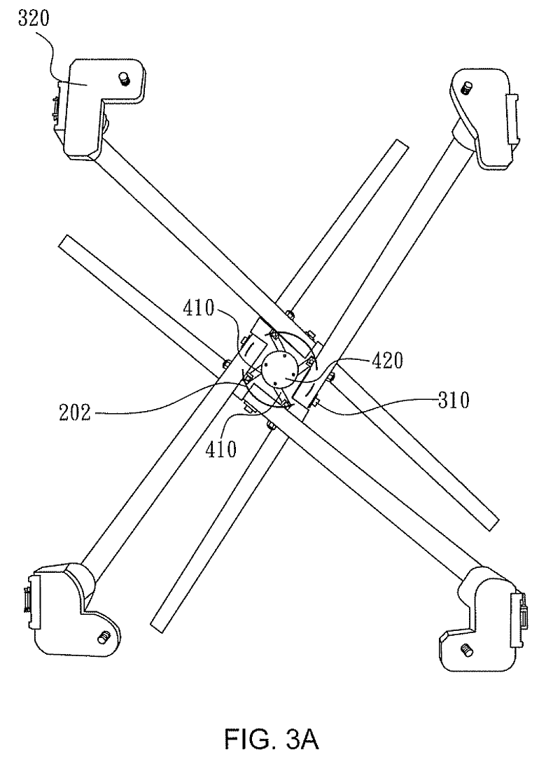

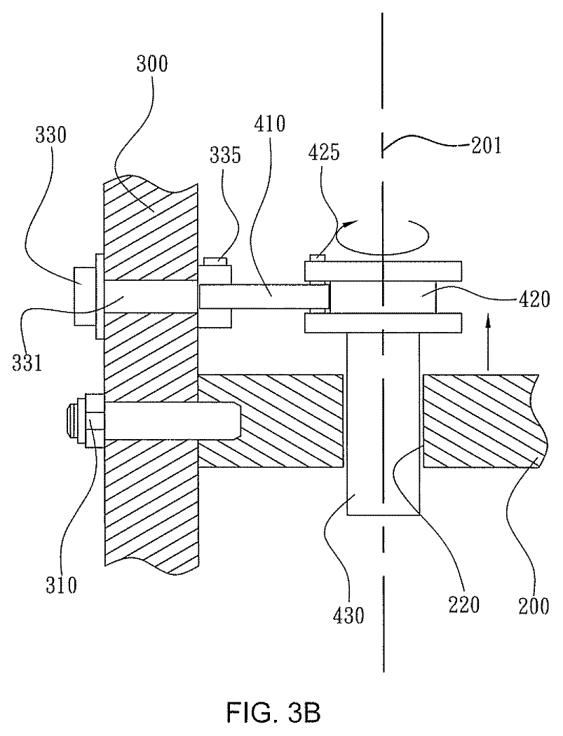

Referring to FIGS. 2, 3A and 3B, a collapsible supporting stand in accordance with a first embodiment of the present disclosure is shown comprised of a center member 200, four supporting posts 300, and an adjustment unit 400.

The center member 200 has four notches 210, a center hole 220 defined therethrough and a center axis 201. According to this embodiment, the center member 200 is a rectangular plate member The four notches 210 are respectively formed on the four side walls 205 of the center member 200. When viewed from the top side, the notches 210 are equiangularly spaced around the periphery 202 of a circle of which the center is in coincidence with the center axis 201 (see FIG. 3A). The center hole 220 is located on the center axis 201 of the center member 200 (see FIG. 3B).

The supporting posts 300 are respectively partially received in the notches 210 and respectively pivotally connected to the center member 200 by a respective first pivot 310. Each supporting post 300 has one end, namely, the top end mounted with a support member 320, which can include a substantially planar supporting surface. Each support member 320 is provided with a retaining ring 322 and has an outer lateral wall 323.

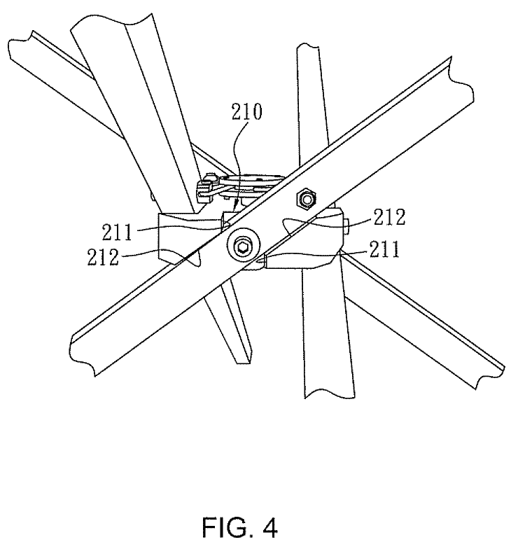

The adjustment unit 400 is installed in the center member 200, comprising four connection members 410, a holder member 420, and a pin 430 connected to the bottom side of the holder member 420. The pin 430 is movably inserted into the center hole 220 of the center member 200 so that the holder member 420 is supported on the center member 200 and can be moved vertically or rotated relative to the center member 200. Each connection member 410 has two opposite ends respectively pivotally connected to a respective second pivot 330 by a first pin 335 and the holder member 420 by a respective second pin 425. The second pivot 330 has a shaft 331 transversely received in the associated supporting post 300 and rotatable relative to the associated supporting post 300 during adjustment of the angle of the associated supporting post 300. Therefore, by way of the respective second pivots 330 and pivot connection between the respective second pivots 330 and the holder member 420 through the respective connection members 410, adjustment of the angles of the supporting posts 300 can be achieved Further, each notch 210 has two opposing vertical walls 211 and two opposing sloping walls 212 respectively provided for supporting the associated supporting post 300 in the collapsed or received non-operative position or the operative position (see FIG. 4).

FIG. 4 is a side view of a part of the collapsible supporting stand in accordance with the first embodiment of the present disclosure.

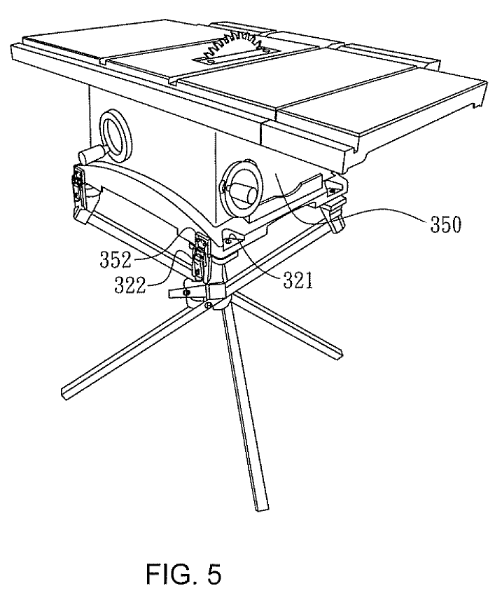

FIG. 5 is an elevational view of the first embodiment of the present disclosure, showing the collapsible supporting stand set in the operative position and a machine tool supported on the collapsible supporting stand. When using the collapsible supporting stand of the first embodiment of the present disclosure, the supporting posts 300 are respectively supported on the sloping walls 212 in the respective notches 210 of the center member 200. At this time, the holder member 420 is kept at the lowest position on the center member 200, and the supporting posts 300 are fully extended and evenly distributed at four sides (see FIG. 3A). Thus, a machine tool 350 is placed on the extended collapsible supporting stand with the four corners of the bottom wall of the machine tool 350 supported on the support members 320. Thereafter, the retaining rings 322 of the supporting posts 300 are respectively hooked on respective hooks 352 at the machine tool 350, thus locking the machine tool 350 to the support members 320. Further, a positioning device 321 can be provided at the top side of the support members 320 to facilitate quick positioning of the machine tool 350 on the collapsible supporting stand.

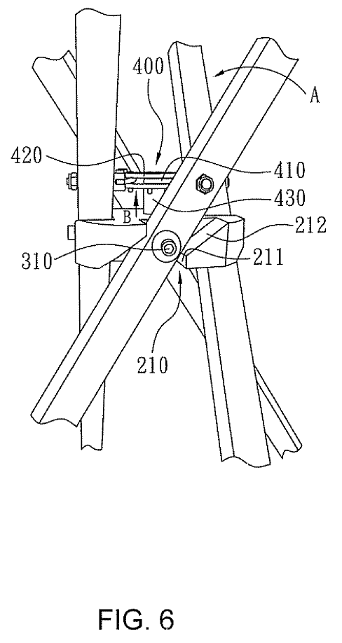

FIG. 6 is a schematic drawing showing the collapsing and receiving operation of the collapsible supporting stand in accordance with the first embodiment of the present disclosure.

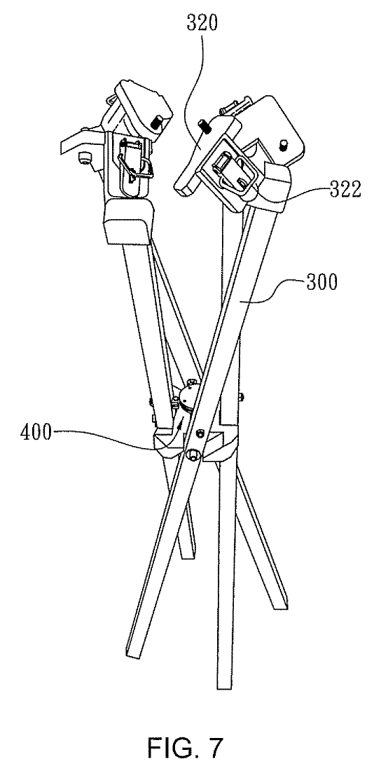

FIG. 7 is an elevational view showing the received status of the collapsible supporting stand in accordance with the first embodiment of the present disclosure. To collapse the collapsible supporting stand into the collapsed and received position, the respective retaining rings 322 are unfastened from the respective hooks 352, and the machine tool 350 is removed from the support members 320. After removal of the machine tool 350 from the support members 320, the user can turn one of the sloping supporting posts 300 about the associated first pivot 310 (see the arrowhead sign A), forcing the associated connection member 410 to move the other supporting posts 300 and to lift (or lower) the holder member 420 (see the arrowhead sign B). Therefore the supporting posts 300 are moved into contact with the respective vertical walls 211 in the notches 210 and are received in a substantially vertical position.

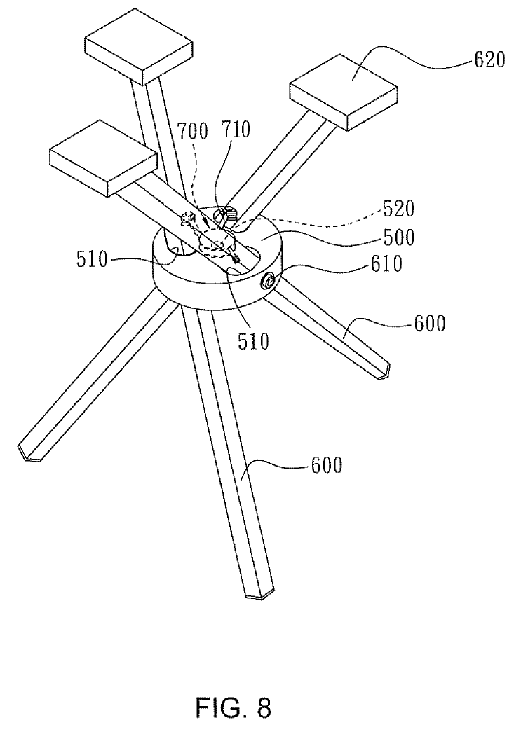

FIG. 8 is an elevational view of a collapsible supporting stand in accordance with a second embodiment of the present disclosure.

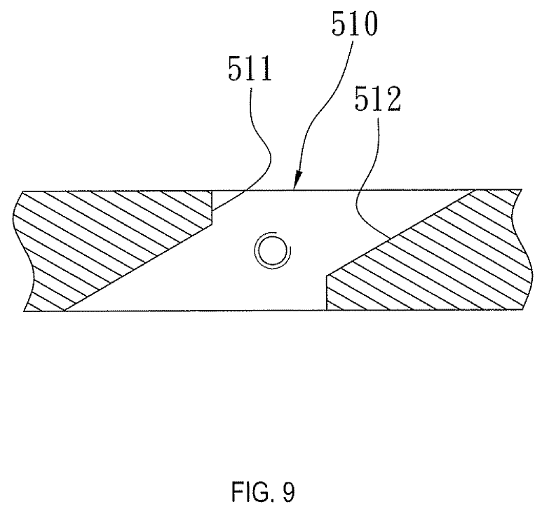

FIG. 9 is a schematic sectional view of a part of the second embodiment of the present disclosure, showing the profile of one through-hole of the center member. According to this second embodiment, the collapsible supporting stand is comprised of a center member 500, three supporting posts 600 and an adjustment unit 700. The center member 500 has three through-holes 510 and a center hole 520. The through-holes 510 are equiangularly spaced around the center hole 520. Further, the center member 500 according to this second embodiment is a circular or triangular plate member. The supporting posts 600 are respectively inserted through the through-holes 510 and are pivotally fastened to the center member 500 by a respective third pivot 610. Each supporting post 600 further has a support member 620 provided at its one end, namely, the top end. Further, the through-holes 510 have a structure similar to the notches 210 of the aforesaid first embodiment (see FIGS. 9 and 4), i.e., each through-hole 510 has two opposing vertical walls 511 and two opposing sloping walls 512 for supporting the associated supporting post 600 in the operative position or the collapsed and received non-operative position.

Further, the adjustment unit 700 according to this second embodiment includes three connection members 710 corresponding to the supporting posts 600. The connection arrangement of the connection members 710 between the associated supporting posts 600 and the center member 500 according to this second embodiment is same as the adjustment unit 400 of the aforesaid first embodiment, and therefore no further detailed description in this regard is necessary.

The second embodiment includes three support members 620, and the connection between the machine tool 350 and the collapsible supporting stand can be achieved in the same manner as the aforesaid first embodiment. Alternatively, any other fastening methods can be employed to lock the machine tool 350 to the collapsible supporting stand. Further, the way of receiving the collapsible supporting stand is same as the receiving operation of the aforesaid first embodiment by way of turning one supporting post 600 to force the associated connection member 710 to move the other supporting posts 600 into contact with the respective associated vertical walls 511.

In conclusion, by way of rotating and lifting/lowering the adjustment unit 400 (700), the supporting posts 300 (600) are shifted between the extended operative position where the supporting posts 300 (600) are respectively in contact with the respective sloping walls 212 (512) and the received non-operative position where the supporting posts 300 (600) are respectively in contact with the respective vertical walls 211 (511).

Although particular embodiments of the disclosure have been described in detail for purposes of illustration, various modifications and enhancements may be made without departing from the spirit and scope of the disclosure. Accordingly, the disclosure is not to be limited except as by the appended claims.

What is claimed is:

1. A collapsible supporting stand, comprising:
a center member having a center hole and at least three receiving portions equiangularly spaced around said center hole;
at least three supporting posts respectively received in said at least three receiving portions and respectively pivotally connected to said center member, each supporting post having a support member fixedly provided at one end thereof; and
an adjustment unit coupled to said center member and vertically movable and horizontally turnable relative to said center member and partially received in said center hole, said adjustment unit including a holder member and at least three connection members respectively pivotally connecting said at least three supporting posts to said holder member, each said connection member having two distal ends respectively pivotally connected to the associated supporting post and said holder member.

2. The collapsible supporting stand according to claim 1, wherein the number of said at least three receiving portions consists of three receiving portions; the number of said at least three supporting posts consists of three supporting posts; and the number of said at least three connection members consists of three connection members.

3. The collapsible supporting stand according to claim 1, wherein said center member is a circular or triangular plate member.

4. The collapsible supporting stand according to claim 1, wherein said receiving portions are defined as through-holes formed through said center member.

5. The collapsible supporting stand according to claim 4, wherein each through-hole comprises two opposing vertical walls and two opposing sloping walls.

6. The collapsible supporting stand according to claim 1, wherein the number of said at least three receiving portions consists of four receiving portions; the number of said at least three supporting posts consists of four supporting posts; the number of said at least three connection members consists of four connection members.

7. The collapsible supporting stand according to claim 1, wherein said center member is a rectangular plate member.

8. The collapsible supporting stand according to claim 1, wherein said receiving portions are notches equiangularly spaced around the periphery of said center member.

9. The collapsible supporting stand according to claim 8, wherein each notch comprises two opposing vertical walls and two opposing sloping walls.

10. The collapsible supporting stand according to claim 1, wherein each support member comprises a retaining ring provided at an outer side thereof arranged to secure a load.

11. The collapsible supporting stand according to claim 1, wherein each support member comprises a positioning device disposed at a top side thereof arranged to position and hold a load.

12. A collapsible supporting stand, comprising:
a center member having at least three receiving portions and a center axis, said at least three receiving portions being equiangularly spaced around a circle defining a center thereof in coincidence with said center axis;
at least three supporting posts respectively received in said at least three receiving portions and respectively pivotally connected to said center member, each supporting post having a support member fixedly provided at one end thereof; and
an adjustment unit coupled to said center member and vertically movable and horizontally turnable relative to said center member, said adjustment unit including a holder member and at least three connection members respectively pivotally connecting said at least three supporting posts to said holder member, each said connection member having two distal ends respectively pivotally connected to the associated supporting post and said holder member.

13. The collapsible supporting stand according to claim 12, wherein said center member further defines a center hole located on said center axis; wherein said adjustment unit is partially received in said center hole.

14. The collapsible supporting stand according to claim 13, wherein said adjustment unit further comprises a pin extended from said holder member and axially movably and rotatably coupled to said center hole of said center member.

15. The collapsible supporting stand according to claim 12, wherein each support member comprises a retaining ring provided at an outer side thereof arranged to secure a load.

16. The collapsible supporting stand according to claim 12, wherein each support member comprises a positioning device disposed at a top side thereof arranged to position and hold a load.
